(19) United States
(12) Patent Application Publication
(10) Pub. No.: US 2014/0378150 A1
(43) Pub. Date: Dec. 25, 2014

(54) METHOD AND APPARATUS FOR PERFORMING D2D COMMUNICATION

(71) Applicants: Chaofeng Li, Beijing (CN); Ming Lei, Beijing (CN)

(72) Inventors: Chaofeng Li, Beijing (CN); Ming Lei, Beijing (CN)

(73) Assignee: NEC (CHINA) CO., LTD., Beijing (CN)

(21) Appl. No.: 14/345,071

(22) PCT Filed: Mar. 16, 2012
(86) PCT No.: PCT/CN2012/072435

§ 371 Date: Sep. 3, 2014

(51) Int. Cl. H04W 52/30; H04W 24/08; H04W 72/08; H04W 76/02

(52) U.S. Cl. CPC H04W 52/30; H04W 76/023; H04W 24/08; H04W 72/085
USPC 455/450

(57) ABSTRACT

Embodiments of the disclosure provide methods and apparatuses for performing D2D communication in a communication system. The communication system at least comprises a BS and a UE in cellular communication with the BS, and wherein the D2D communication is performed between a D2D transmitter and a D2D receiver and interferes with the cellular communication. A method according to the disclosure may comprise steps of: obtaining MCS information on the cellular communication between the BS and the UE; and determining a transmitting power for the D2D communication based on the MCS information, so as to reduce the interference from the D2D communication to the cellular communication.

### FIELD OF THE INVENTION

Embodiments of the present invention generally relate to communication techniques. More particularly, embodiments of the present invention relate to a method and apparatus for performing D2D (Device-to-Device) communication.

### BACKGROUND OF THE INVENTION

A next generation mobile wireless communication system generally provides a high speed multimedia service. For example, 3GPP LTE and LTE-Advanced are one of the next generation cellular communication standards, which create a new series of specifications for the new evolving radio-access technology. With the use of multimedia service becoming more widespread, wireless communication users' demand for faster, more reliable, and better multimedia is growing.

To accommodate such a growing demand, research to provide more efficient and improved service is taking place. In other words, various methods of improving data transmission are being researched, and in particular, ways to improve use of frequency resources are being explored.

Due to the increasing demand for higher throughput, the tendency of offloading cellular network traffic has received enormous attention, e.g., femto and other small cells. Increasing demand of offloading cellular traffic has attracted attention from most industrial partners to the D2D communication. The aim of D2D communication is pursuing this track to allow mobile terminals to transmit data to each other without, or with limited help from the infrastructure.

In order to efficiently utilizing spectrum, same frequency band is allowed to be shared by both cellular users and D2D devices. However, when the same subcarrier or frequency band is allocated for D2D communication and cellular communication at the same time, the interference to each other would highly degrade the communication quality for both of uplink cellular communication (“uplink” hereafter) and downlink cellular communication (“downlink” hereafter).

In view of the foregoing problem, there is a need to reduce the interference from D2D communication to cellular communication in both uplink and downlink, so as to effectively improve performance of a communication system comprising both the D2D communication and cellular communication.

### SUMMARY OF THE INVENTION

The present invention proposes a solution which reduces the interference from D2D communication to cellular communication in both uplink and downlink. Specifically, the present invention provides a method and apparatus for performing D2D communication in a communication system.

According to a first aspect of the present invention, embodiments of the invention provide a method for performing D2D (Device-to-Device) communication in a communication system. The communication system may at least comprise a base station (BS) and a user equipment (UE) in cellular communication with the BS, and wherein the D2D communication is performed between a D2D transmitter and a D2D receiver and interferes with the cellular communication. The method may comprise steps of: obtaining modulation and coding scheme (MCS) information on the cellular communication between the BS and the UE; and determining a transmitting power for the D2D communication based on the MCS information, so as to reduce the interference from the D2D communication to the cellular communication.

According to a second aspect of the present invention, embodiments of the invention provide an apparatus for performing D2D (Device-to-Device) communication in a communication system. The communication system may at least comprise a base station (BS) and a user equipment (UE) in cellular communication with the BS, and wherein the D2D communication is performed between a D2D transmitter and a D2D receiver and interferes with the cellular communication. The apparatus may comprise: obtaining unit configured to obtain modulation and coding scheme (MCS) information on the cellular communication between the BS and the UE; and determining unit configured to determine a transmitting power for the D2D communication based on the MCS information, so as to reduce the interference from the D2D communication to the cellular communication.

The following benefits are expected with the invention. The spectral efficiency scheme can be improved by allowing the D2D communication to share the wireless resources with cellular communication. Additionally, interference of both interfering links, i.e. the one from D2D transmitter to cellular base station (BS) and the one from other cellular user equipments (UEs) to the D2D receiver in a cellular uplink session, or the one from D2D transmitter to cellular UEs and the one from the cellular BS to the D2D receiver in a cellular downlink session, have been taken into account in the disclosure. The overhead consumption for D2D communication is reduced by allowing D2D transmitter (also called as “Tx”) to receive control messages which cater for the specific cellular UEs. In other words, the BS does not need to explicitly send MCS information to all D2D transmitters or receivers.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where

FIG. 1A illustrates a schematic diagram of a communication system in which the uplink cellular communication is interfered by the D2D communication;

FIG. 1B illustrates a schematic diagram of a communication system in which the downlink cellular communication is interfered by the D2D communication;

FIG. 2 illustrates a flow chart of a method 200 for performing D2D communication in a communication system according to embodiments of the invention;

FIG. 3 illustrates a flow chart of a method 300 for performing D2D communication in a communication system according to further embodiments of the invention;

FIG. 4 illustrates a flow chart of a method 400 for performing D2D communication in a communication system according to further embodiments of the invention; and

FIG. 5 illustrates a block diagram of an apparatus 500 for performing D2D communication in a communication system according to embodiments of the invention.

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

In the disclosure, a user equipment (UE) may refer to a terminal, a Mobile Terminal (MT), a Subscriber Station (SS), a Portable Subscriber Station (PSS), Mobile Station (MS), or an Access Terminal (AT), and some or all of the functions of the UE, the terminal, the MT, the SS, the PSS, the MS, or the AT may be included.

In the disclosure, a base station (BS) may refer to a node B (NodeB or NB) or an evolved NodeB (eNodeB or eNB). A base station may be a macrocell BS or a small cell BS. According to the present invention, a macrocell BS may be a base station which manages a macrocell, for example, a macro eNB, and a small cell BS may be a base station which manages a small cell, for example, a pico eNB, a femto eNB, and some other suitable low power nodes.

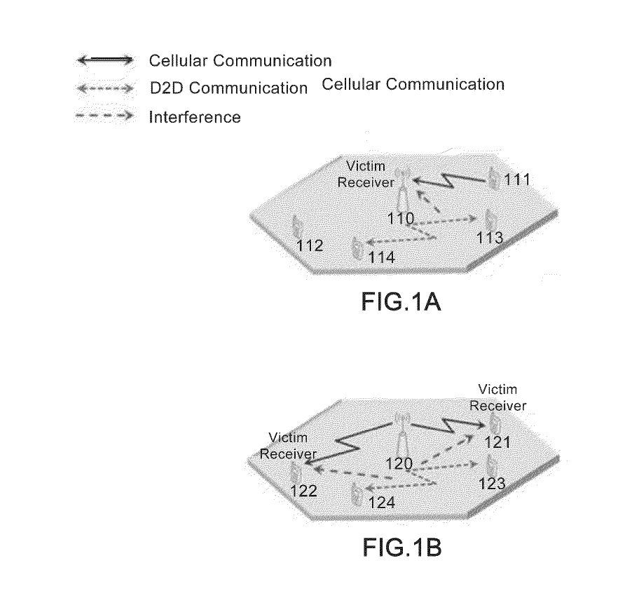

Reference is first made to FIG. 1A, which illustrates a schematic diagram of a communication system in which the uplink cellular communication is interfered by the D2D communication.

The communication environment of FIG. 1A illustrates a LTE system. The system illustratively comprises a BS 110, a UE 111, a UE 112, a D2D transmitter 113 and a D2D receiver 114. In the system, the UE 111 is being served by the BS 110, specifically, the UE 111 is communicating with the BS 110 in uplink (i.e., the UE 111 and the BS 110 are in uplink cellular communication); and the D2D transmitter 113 and a D2D receiver 114 are in D2D communication, specifically, the D2D transmitter 113 is transmitting data to the D2D receiver 114. As can be appreciated by those skilled in the art, in other embodiments of the present invention, in another D2D communication, the D2D receiver 114 may play a role of a D2D transmitter for transmitting data and the D2D transmitter 113 may play a role of a D2D receiver for receiving data. Thus, the D2D transmitter 113 and the D2D receiver 114 are only illustrated in FIG. 1A for example, rather than limitation.

As can be seen from FIG. 1A, during the D2D communication, especially when the D2D transmitter 113 is transmitting data to the D2D receiver 114, the BS 110 may suffer the interference from the D2D transmitter 113 when receiving data transmitted in the uplink from the UE 111. At this time, the BS 110 may be considered as a “victim receiver”.

Reference is now made to FIG. 1B, which illustrates a schematic diagram of a communication system in which the downlink cellular communication is interfered by the D2D communication.

The communication environment of FIG. 1B illustrates a LTE system. The system illustratively comprises a BS 120, a UE 121, a UE 122, a D2D transmitter 123 and a D2D receiver 124. In the system, the UE 121 is being served by the BS 120, specifically, the BS 120 is transmitting data to the UE 121 in downlink (i.e., the UE 121 and the BS 120 are in downlink cellular communication); the UE 122 is also being served by the BS 120, specifically, the BS 120 is transmitting data to the UE 122 in downlink (i.e., the UE 122 and the BS 120 are in downlink cellular communication); and the D2D transmitter 123 and a D2D receiver 124 are in D2D communication, specifically, the D2D transmitter 123 is transmitting data to the D2D receiver 124. As can be appreciated by those skilled in the art, in other embodiments of the present invention, in another D2D communication, the D2D receiver 124 may play a role of a D2D transmitter for transmitting data and the D2D transmitter 123 may play a role of a D2D receiver for receiving data. Thus, the D2D transmitter 123 and the D2D receiver 124 are only illustrated in FIG. 1B for example, rather than limitation.

As can be seen from FIG. 1B, during the D2D communication, especially when the D2D transmitter 123 is transmitting data to the D2D receiver 124, the UE 121 and/or the UE 122 may suffer the interference from the D2D transmitter 113 when receiving data transmitted in the downlink from the BS 120. At this time, the UE 121 and/or the UE 122 may be considered as a “victim receiver”.

According to embodiments of the present invention, the D2D transmitter and the D2D receiver may be located within one cell, or located in different neighboring cells. In embodiments where the D2D transmitter and the D2D receiver are located within one cell, when the cellular communication is in uplink, the “victim receiver” may be the BS manages the cell; and when the cellular communication is in downlink, the “victim receiver” may be one or more UEs which are communicating with the BS in downlink. In embodiments where the D2D transmitter and the D2D receiver are located in different neighboring cells, when the cellular communication is in uplink, the “victim receiver” may be the BS manages the cell in which the D2D transmitter is located; and when the cellular communication is in downlink, the “victim receiver” may be one or more UEs which are communicating with the BS (which manages the cell in which the D2D transmitter is located) in downlink.

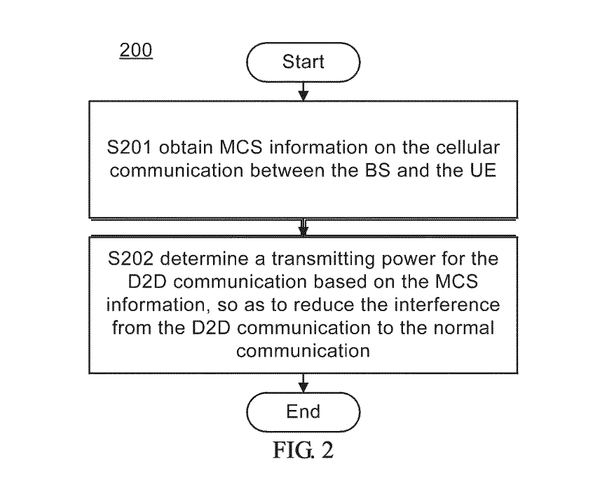

Reference is now made to FIG. 2, which illustrates a flow chart of a method 200 for performing D2D communication in a communication system according to embodiments of the invention. According to embodiments of the present invention, the communication system may at least comprise a BS and a UE in cellular communication with the BS, and wherein the D2D communication is performed between a D2D transmitter and a D2D receiver and interferes with the cellular communication. According to embodiments of the present invention, the communication system may be implemented as the system illustrated in FIG. 1A or FIG. 1B.

At step S201, MCS information on the cellular communication between the BS and the UE is obtained.

According to embodiments of the present invention, the cellular communication may be in uplink, that is, an uplink cellular communication. In this case, the MCS information on the cellular communication between the BS and the UE may be obtained by obtaining the MCS information transmitted from the BS to the UE, wherein the MCS information is designated by the BS to the UE.

According to embodiments of the present invention, the cellular communication may be in downlink, that is, a downlink cellular communication. In this case, the MCS information on the cellular communication between the BS and the UE may be obtained by obtaining the MCS information transmitted from the BS to the UE, wherein the MCS information is determined by the BS based on CQI measured by the UE in response to receiving reference signals from the BS.

At step S202, a transmitting power for the D2D communication is determined based on the MCS information, so as to reduce the interference from the D2D communication to the normal communication.

According to embodiments of the present invention, the transmitting power for the D2D communication may be determined by obtaining a power limit for all of at least one shared subband which is shared by the D2D communication and the cellular communication based on the MCS information; and determining the transmitting power for the D2D communication based on the power limit.

According to embodiments of the present invention, the cellular communication is in uplink. In this case, the power limit for all of the at least one shared subband may be determined by obtaining the channel information from the UE to the BS based on the MCS information; obtaining channel information from the D2D transmitter to the BS based on pathloss from the D2D transmitter to the BS; and calculating the power limit for all of the at least one shared subband based on the channel information from the UE to the BS, the channel information from the D2D transmitter to the BS, and outage probability of the uplink. According to embodiments of the present invention, the channel information from the D2D transmitter to the BS may be obtained by calculating the pathloss from the BS to the D2D transmitter based on reference signals sent from the BS; and obtaining the pathloss from the D2D transmitter to the BS based on channel reciprocity and the pathloss from the BS to the D2D transmitter.

According to embodiments of the present invention, the cellular communication is in downlink. In this case, the power limit for all of the at least one shared subband may be determined by obtaining the channel information from the UE to the BS based on the MCS information; obtaining channel information from the D2D transmitter to the UE based on pathloss from the D2D transmitter to the UE; and calculating the power limit for all of the at least one shared subband based on the channel information from the UE to the BS, the channel information from the D2D transmitter to the UE, and outage probability of the downlink. According to embodiments of the present invention, the channel information from the D2D transmitter to the UE may be obtained by determining the distance between the D2D transmitter and the UE; and calculating the pathloss from the D2D transmitter to the UE based on the distance between the D2D transmitter and the UE.

According to embodiments of the present invention, the transmitting power for the D2D communication may be determined by obtaining the total power limitation at the D2D transmitter; and determining the transmitting power for the D2D communication based on the power limit for all of the at least one shared subband and the total power limitation. According to embodiments of the present invention, the transmitting power for the D2D communication may be determined by obtaining interference suffered by the D2D receiver; calculating a transmission rate for each of the at least one shared subband based on the obtained interference; and obtaining a subband transmitting power for each of the at least one shared subband by maximizing the sum of the calculated transmission rate, wherein each subband transmitting power does not exceed the power limit for the corresponding subband, and the sum of subband transmitting powers does not exceed the total power limitation. According to embodiments of the present invention, the interference suffered by the D2D receiver may be long term interference, instantaneous interference, or some other interference. In some embodiments, the long term interference may be estimated based on historical interference at the D2D receiver or set as a predetermined value. In some embodiments, the instantaneous interference may be measured by the D2D receiver for each of the at least one shared subband which is shared by the UE and the D2D transmitter. As such, the interference suffered by the D2D receiver may be obtained by obtaining either the long term interference to the D2D receiver or the instantaneous interference to the D2D receiver.

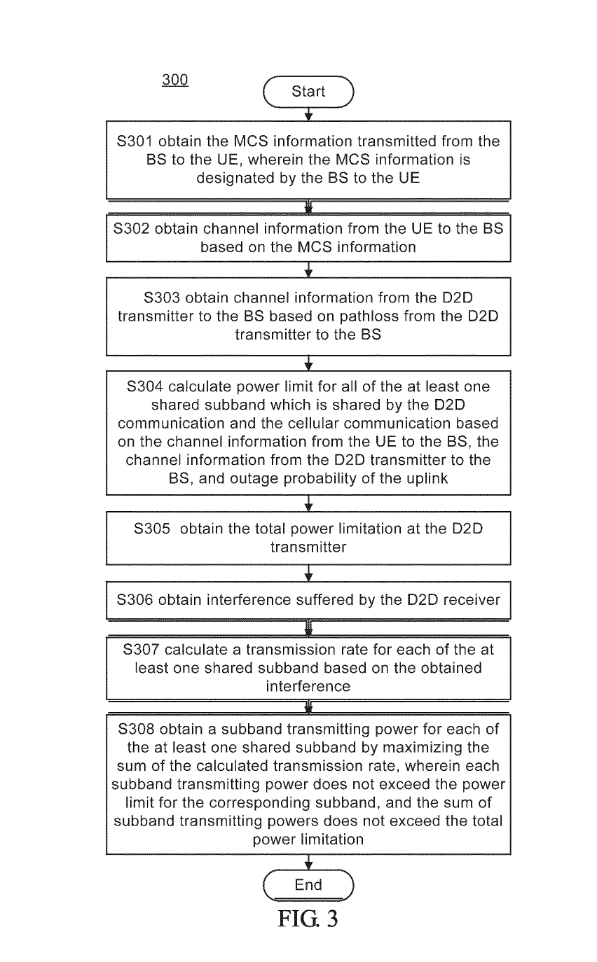

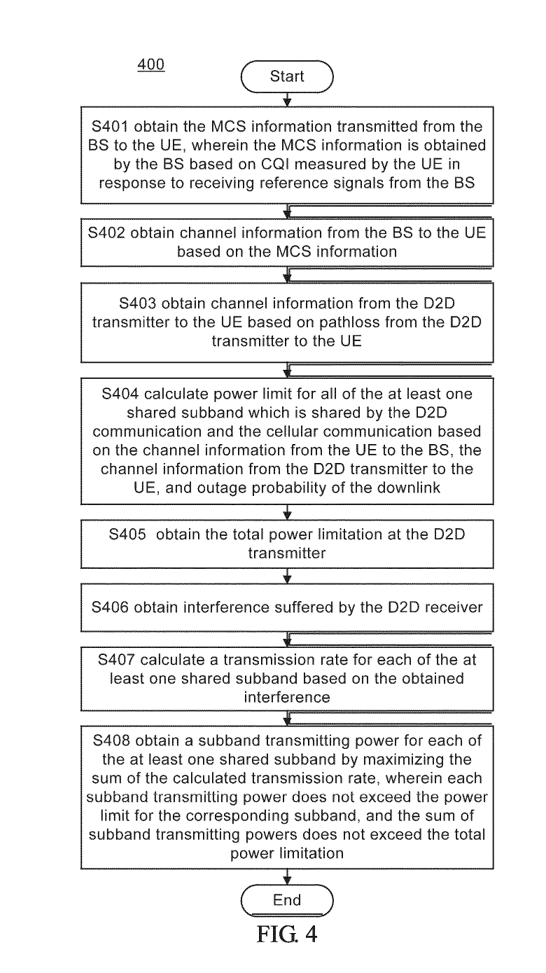

Reference is now made to FIG. 3, which illustrates a flow chart of a method 300 for performing D2D communication in a communication system according to further embodiments of the invention. According to embodiments of the present invention, the communication system may at least comprise a BS and a UE in cellular communication with the BS, and wherein the D2D communication is performed between a D2D transmitter and a D2D receiver and interferes with the cellular communication. According to embodiments of the present invention, the communication system may be implemented as the system illustrated in FIG. 1A or FIG. 1B. In embodiments illustrated by FIG. 3, the cellular communication is in uplink, that is, an uplink cellular communication. Differently, in embodiments illustrated by FIG. 4, the cellular communication is in downlink, that is, a downlink cellular communication.

At step S301, MCS information on the cellular communication between the BS and the UE is obtained, which is designated by a BS to the UE.

According to embodiments of the present invention, the MCS information may be designated by the BS to the UE, and then the BS may transmit the MCS information to the UE. The D2D transmitter may listen to the MCS information sent from the BS to the UE and obtain the MCS information transmitted from the BS to the UE.

According to embodiments of the present invention, the MCS information may at least comprise a MCS index which indicates the modulation and coding scheme designated by the BS for the UE. The UE may use the modulation and coding scheme designated by the MCS information to perform cellular communication, e.g., uplink cellular communication with the BS.

In some embodiments of the present invention, the BS may signal D2D transmitter which subbands can be shared through downlink control channel. D2D transmitter may listen to the downlink control channel and find at least one shared uplink subband. Based on the obtained MCS information, the D2D transmitter may know corresponding transmission mode at least one shared subband, such as MCS, Quan-SINR, etc.

At step S302, channel information from the UE to the BS is obtained based on the MCS information.

According to embodiments of the present invention, the D2D transmitter may decide its transmission power on each shared subband by solving throughput maximization problem and waits for the upcoming uplink session. For solving the throughput maximization problem, the D2D transmitter may acquire some parameters in advance, for example, the channel information from the UE to the BS, channel information from the D2D transmitter to the BS, total power limitation at the D2D transmitter, and so on.

In the embodiments, the channel information from the UE to the BS may comprise channel gain from the UE to the BS, long-term mean value and distribution of the channel, and so on. The long-term mean value may be obtained based on pathloss of the channel, and the distribution may be Rayleigh, which represents fast fading, for example. In some embodiments, reference signals may be employed in obtaining the channel gain from the UE to the BS, and the channel gain may be varied in a range of values corresponding to a set of modulation and coding schemes. According to embodiments of the present invention, the employed modulation and coding scheme may be determined from the MCS information, which may be obtained in step S301.

At step S303, channel information from the D2D transmitter to the BS is obtained based on pathloss from the D2D transmitter to the BS.

In the embodiments, the channel information from the D2D transmitter to the BS may be statistical information on the channel from the D2D transmitter to the BS, for example, the mean value, distribution, and so on of the pathloss from the D2D transmitter to the BS.

According to embodiments of the present invention, the pathloss from the D2D transmitter to the BS may be obtained by several ways. For example, the pathloss from the BS to the D2D transmitter may be calculated based on reference signals sent from the BS, and then the pathloss from the D2D transmitter to the BS may be obtained based on channel reciprocity and the pathloss from the BS to the D2D transmitter.

At step S304, the power limit for all of the at least one shared subband which is shared by the D2D communication and the cellular communication is calculated based on the channel information from the UE to the BS, the channel information from the D2D transmitter to the BS, and outage probability of the uplink.

According to embodiments of the present invention, the outage probability of the uplink may be predetermined at the BS. For example, the outage probability of the uplink may be set according to experience of the operator of the communication system or those skilled in the art. For another example, the outage probability of the uplink may be set according to concrete communication conditions of the communication system.

In the embodiments, the channel information from the UE to the BS may be denoted as g, the channel information from the D2D transmitter to the BS may be denoted as h_{D,BS}, and the outage probability of the uplink may be denoted as ε_{UL}. For example, the outage probability of the uplink ε_{UL} may be 10%. According to embodiments of the present invention, the power limit P̅_{D,I} may be obtained based on the applicable power for all of the at least one shared subband. For example, the power limit P̅_{D,l} may be set as the maximum value of the applicable power. In embodiments of the present invention, the applicable power (denoted as P_{D,l}) may be calculated from the following formula:

$$\frac{g \cdot {P}_{UE}}{{N}_{0} + I + {h}_{D , BS} \cdot {P}_{D , l}} < {ɛ}_{UL} \qquad ( 1 )$$

wherein P_{D,I} represents the applicable power for all of the at least one shared subband (for example, if there are totally S shared subbands, P_{D,l} represents applicable power for the S shared subbands); the subscript l represents the l^{th} modulation and coding scheme obtained based on the MCS information; the subscript D represents that it is related to the D2D transmitter; P_{UE} represents transmission power of the UE; N₀ is the background noise; and I indicates the intercell interference (ICI). As can be appreciated by those skilled in the art, N₀ and I may be obtained according to existing means, so the relevant details are omitted here. For example, by assuming that channel gains follow Rayleigh distribution, P_{UE}, and the variance of N₀ and I may be constant. Thus, it can be analytically derived the explicit form of the maximum transmission power of the D2D transmitter, that is, the power limit of the D2D transmitter for the l^{th} shared subband.

According to embodiments of the present invention, there may be several UEs which are in cellular communication with the BS. Thus, there may be several uplink sessions between the BS and different UEs. With respect to the n^{th} UE, “g” shown in the formula (1) represents the channel information from the n^{th} UE to the BS. For purpose of simplicity, the embodiments simply take the n^{th} UE for example. Those skilled in the art will understand, in the case that there are several UEs in the uplink cellular communication with the BS, the methods according to the present invention are also applicable.

At step S305, the total power limitation at the D2D transmitter is obtained.

According to embodiments of the present invention, the total power limitation at the D2D transmitter may be predetermined by its producer, operator, marketer, etc. Alternatively, the total power limitation at the D2D transmitter may be set as a fixed value according to specific conditions of the communication system to which it is applied. Those skilled in the art will understand that the total power limitation at the D2D transmitter may be obtained in various ways, and the above examples are shown for illustration, rather than limitation.

At step S306, interference suffered by the D2D receiver is obtained.

The interference suffered by the D2D receiver may be obtained by obtaining long term interference to the D2D receiver. According to embodiments of the present invention, the long term interference may be estimated based on historical interference at the D2D receiver or set as a predetermined value. In some embodiments, the long term interference may be determined by the D2D receiver or some other apparatus for which information on historical interference is available, and then the D2D receiver or some other apparatus may sent the long term interference to the D2D transmitter periodically or at predefined instants. In some other embodiments, the long term interference may be determined by the D2D transmitter, and in this case, the D2D transmitter may collect the information on historical interference at the D2D receiver periodically or at predefined instants to derive the long term interference.

The interference suffered by the D2D receiver may be obtained by obtaining instantaneous interference to the D2D receiver. According to embodiments of the present invention, the instantaneous interference may be measured by the D2D receiver for each of the at least one shared subband which is shared by the UE and the D2D transmitter. For example, the D2D receiver may measure the instantaneous interference in response to the request from the D2D transmitter, and then report it to the D2D transmitter. For another example, the D2D receiver may measure the instantaneous interference periodically or at predefined instants and report it to the D2D transmitter initiatively or periodically.

At step S307, a transmission rate for each of the at least one shared subband is calculated based on the obtained interference.

According to embodiments of the present invention, the transmission rate for a shared subband may be calculated in several ways. For example, assuming there are S subbands which are shared between the D2D transmitter and the UE, the transmission rate for the s^{th} shared subband may be obtained by the following formula:

Rₛ=log(1+kₛP_{D,I(s),s}) (2)

where Rₛ represents the transmission rate for the s^{th} shared subband; P_{D,I(s),s} represents the transmission power to be employed by the D2D transmitter for the s^{th} subband in view of the l^{h} modulation and coding scheme (for example, l may be the MCS index comprised in the obtained MCS information); and kₛ is the tuning parameter for each subband related with the interference level at the D2D receiver.

According to embodiments of the present invention, kₛ may be obtained as follows:

$${κ}_{s} = \frac{{ε}_{D} {\overline{g}}_{D}}{( 1 - {ε}_{D} ) {I}_{D , s} - {ε}_{D} {σ}^{2} / log ( 1 - {ε}_{D} )} \qquad ( 3 )$$

wherein ^{∈}D represents the outage threshold for the D2D transmission; g̅_{D} represents the average channel gain between the D2D transmitter and the D2D receiver; I_{D,s} represents the interference level at the D2D receiver on subband s; and σ² represents the background Gaussian noise power.

At step S308, a subband transmitting power for each of the at least one shared subband is obtained by maximizing the sum of the calculated transmission rate, wherein each subband transmitting power does not exceed the power limit for the corresponding subband, and the sum of subband transmitting powers does not exceed the total power limitation.

According to embodiments of the present invention, the subband transmitting power for each of the at least one shared subband may be denoted as P_{D,I(s),s} which, as motioned above, represents the subband transmission power for the s^{th} subband in view of the l^{h} modulation and coding scheme. In the embodiments, P_{D,I(s),s} may be obtained by maximizing the sum of the calculated transmission rate, meanwhile meeting the requirements that each subband transmitting power does not exceed the power limit for the corresponding subband, and the sum of subband transmitting powers does not exceed the total power limitation. Specifically, P_{D,I(s),s} may be obtained by solving the following:

$$max \cdot {\sum }_{s = 1}^{S} log ( 1 + {κ}_{s} {P}_{D , l ( s ) , s} ) \\ s . t . {P}_{D , l ( s ) , s} \leq {\overline{P}}_{D , l} , ∀ s , l \\ {\sum }_{s = 1}^{S} {P}_{D , l ( s ) , s} \leq {\overline{P}}_{D} \qquad ( 4 )$$

where P̅_{D,I} represents the power limit for all of the at least one shared subband; and P̅_{D} represents the total power limitation at the D2D transmitter, which may be obtained at step S305.

Although the aforesaid exemplarily illustrates a solution which is classical water-filling algorithm with various interference level I_{D,s} for each subband, those skilled in the art will readily understand that there are several other ways to define other requirements to be met in obtaining the subband transmitting power for each of the at least one shared subband. In some embodiments of the present invention, the interference level may be instantaneous interference to the D2D receiver. If the instantaneous interference is not available at the D2D transmitter, the D2D transmitter may refer to the long term interference and apply it to all subbands.

After obtaining the subband transmitting power for each of the at least one shared subband, the transmitting power to be used by the D2D transmitter may be determined accordingly.

Those skilled in the art will readily understand that the channel information may be obtained by using several known means in the art.

Reference is now made to FIG. 4, which illustrates a flow chart of a method 400 for performing D2D communication in a communication system according to further embodiments of the invention. According to embodiments of the present invention, the communication system may at least comprise a BS and a UE in cellular communication with the BS, and wherein the D2D communication is performed between a D2D transmitter and a D2D receiver and interferes with the cellular communication. According to embodiments of the present invention, the communication system may be implemented as the system illustrated in FIG. 1A or FIG. 1B. As mentioned before, in embodiments illustrated by FIG. 4, the cellular communication is in downlink, that is, a downlink cellular communication, which is different from the uplink cellular communication as illustrated with respect to FIG. 3.

In a downlink cellular communication, there are several aspects are different from the uplink cellular communication. At one aspect, the BS may decide the MCS information index after receiving the channel quality index (CQI) from the UE side, and then may inform the corresponding D2D transmitter; differently, in the uplink session, the BS may decide the MCS information instantaneously after measuring the pilot symbols from the UE. At another aspect, the path loss between the D2D transmitter and the UE (UE is a victim receiver in the downlink cellular communication) may be calculated or estimated if D2D transmitter aspires to share the downlink resources with the UE; differently, in the uplink session, it is the pathloss from the D2D transmitter to the BS that may be used.

At step S401, MCS information on the cellular communication between the BS and the UE is obtained, which is obtained by the BS based on CQI measured by the UE in response to receiving reference signals from the BS.

According to embodiments of the present invention, the BS may send reference signals (RSs, e.g. CBS, DM-RS in LTE) to the UE. The UE may measure the channel through the received RS s and send CQI back to the BS. In the meantime, the BS may estimate the location of the UEs whose downlink resources are going to be shared by D2D devices. The MCS information (e.g., MCS index) for the next downlink session may be determined by the BS from the CQI feedbacks.

In some embodiments of the present invention, the BS may transmit the MCS information to the UE. The D2D transmitter may listen to the MCS information sent from the BS to the UE and obtain the MCS information transmitted from the BS to the UE.

The MCS information may at least comprise a MCS index which indicates the modulation and coding scheme designated by the BS for the UE. The UE may use the modulation and coding scheme designated by the MCS information to perform cellular communication, e.g., downlink cellular communication with the BS.

At step S402, the channel information from the BS to the UE is obtained based on the MCS information.

According to embodiments of the present invention, the D2D transmitter may decide its transmission power on each shared subband by solving throughput maximization problem and waits for the upcoming downlink session. For solving the throughput maximization problem, the D2D transmitter may acquire some parameters in advance, for example, the channel information from the BS to the UE, channel information from the D2D transmitter to the UE, total power limitation at the D2D transmitter, and so on.

In the embodiments, the channel information from the BS to the UE may comprise channel gain from the BS to the UE, long-term mean value and distribution of the channel, and so on. The long-term mean value may be obtained based on pathloss of the channel, and the distribution may be Rayleigh, which represents fast fading, for example. In some embodiments, reference signals may be employed in obtaining the channel gain from the BS to the UE, and the channel gain may be varied in a range of values corresponding to a set of modulation and coding schemes. According to embodiments of the present invention, the employed modulation and coding scheme may be determined from the MCS information, which may be obtained in step S401.

At step S403, channel information from the D2D transmitter to the UE is obtained based on pathloss from the D2D transmitter to the UE.

When the location of the UE is obtained by BS (by either GPS devices embedded in UE, or LTE location services with helps of other BSs), the D2D transmitter may calculate the distance between itself and the UE. Pathloss may be derived from this distance with various channel models or wireless com scenarios, e.g. UMa, UMi, and so on.

According to embodiments of the present invention, the pathloss from the D2D transmitter to the UE may be obtained by determining the distance between the D2D transmitter and the UE; and calculating the pathloss from the D2D transmitter to the UE based on the distance between the D2D transmitter and the UE. According to embodiments of the present invention, the distance between the D2D transmitter and the UE may be determined in several ways. For example, the D2D transmitter may request the BS for the UE's location and calculate the distance between itself and the UE. Alternatively, the D2D transmitter may communicate directly with the UE directly and ask the UE for its location. Those skilled in the art will understand, the above examples are only for illustration, and several other ways may be implemented to obtain the pathloss from the D2D transmitter to the UE.

At step S404, the power limit for all of the at least one shared subband which is shared by the D2D communication and the cellular communication is calculated based on the channel information from the UE to the BS, the channel information from the D2D transmitter to the UE, and outage probability of the downlink.

According to embodiments of the present invention, the outage probability of the downlink may be predetermined at the BS. For example, the outage probability of the downlink may be set according to experience of the operator of the communication system or those skilled in the art. For another example, the outage probability of the downlink may be set according to concrete communication conditions of the communication system.

In the embodiments, the channel information from the BS to the UE may be denoted as g, the channel information from the D2D transmitter to the UE may be denoted as h_{D,UE}, and the outage probability of the downlink may be denoted as ε_{DL}. For example, the outage probability of the downlink E_{DL} may be 10%. According to embodiments of the present invention, the power limit P̅_{D,I} may be obtained based on the applicable power for all of the at least one shared subband. For example, the power limit P̅_{D,I} may be set as the maximum value of the applicable power. In embodiments of the present invention, the applicable power (denoted as P_{D,l}) may be calculated from the following formula:

$$\frac{g \cdot {P}_{BS}}{{N}_{0} + I + {h}_{D , UE} \cdot {P}_{D , l}} < {ɛ}_{DL} \qquad ( 5 )$$

wherein P_{D,I} represents the applicable power for all of the at least one shared subband (for example, if there are totally S shared subbands, P_{D,l} represents applicable power for the S shared subbands); the subscript l represents the l^{th} modulation and coding scheme obtained based on the MCS information; the subscript D represents that it is related to the D2D transmitter; P_{BS} represents transmission power of the BS; N₀ is the background noise; and I indicates the intercell interference (ICI). As can be appreciated by those skilled in the art, N₀ and l may be obtained according to existing means, so the relevant details are omitted here. For example, by assuming that channel gains follow Rayleigh distribution, P_{BS}, and the variance of N₀ and I may be constant. Thus, it can be analytically derived the explicit form of the maximum transmission power of the D2D transmitter, that is, the power limit of the D2D transmitter for the l^{th} shared subband.

According to embodiments of the present invention, there may be several UEs which are in cellular communication with the BS. Thus, there may be several downlink sessions between the BS and different UEs. With respect to the n^{th} UE, “g” shown in the formula (5) represents the channel information from the BS to the n^{th} UE. For purpose of simplicity, the embodiments simply take the n^{th} UE for example, thus the label “n” does not appears in formula (5). Those skilled in the art will understand, in the case that there are several UEs in the uplink cellular communication with the BS, the methods according to the present invention are also applicable.

At step S405, the total power limitation at the D2D transmitter is obtained.

According to embodiments of the present invention, the total power limitation at the D2D transmitter may be predetermined by its producer, operator, marketer, etc. Alternatively, the total power limitation at the D2D transmitter may be set as a fixed value according to specific conditions of the communication system to which it is applied.

This step is similar to step S305, and all details discussed in step S305 are applicable to step S405.

At step S406, interference suffered by the D2D receiver is obtained.

According to embodiments of the present invention, the interference suffered by the D2D receiver may be obtained by obtaining long term interference or instantaneous interference to the D2D receiver.

This step is similar to step S306, and all details discussed in step S306 are applicable to step S406.

At step S407, a transmission rate for each of the at least one shared subband is calculated based on the obtained interference. According to embodiments of the present invention, the transmission rate for a shared subband may be calculated in several ways. For example, assuming there are S subbands which are shared between the D2D transmitter and the UE, the transmission rate for the s^{th} shared subband may be obtained by formula (2) and (3).

At step S408, a subband transmitting power for each of the at least one shared subband is obtained by maximizing the sum of the calculated transmission rate, wherein each subband transmitting power does not exceed the power limit for the corresponding subband, and the sum of subband transmitting powers does not exceed the total power limitation.

According to embodiments of the present invention, the subband transmitting power for each of the at least one shared subband may be denoted as P_{D,I(s),s}, which, as motioned above, represents the subband transmission power for the s^{th} subband in view of the l^{th} modulation and coding scheme. In the embodiments, P_{D,I(s),s} may be obtained by maximizing the sum of the calculated transmission rate, meanwhile meeting the requirements that each subband transmitting power does not exceed the power limit for the corresponding subband, and the sum of subband transmitting powers does not exceed the total power limitation. Specifically, P_{D,I(s),s} may be obtained by solving the formula (4).

After obtaining the subband transmitting power for each of the at least one shared subband, the transmitting power to be used by the D2D transmitter may be determined accordingly.

Those skilled in the art will readily understand that the channel information may be obtained by using several known means in the art.

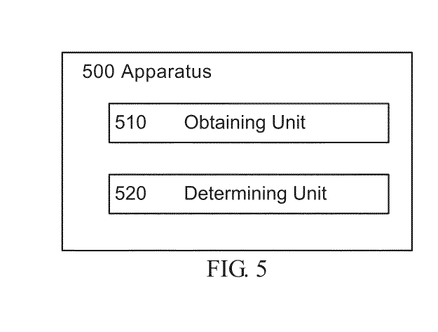

Reference is now made to FIG. 5, which illustrates a block diagram of an apparatus 500 for performing D2D communication in a communication system according to embodiments of the invention. According to embodiments of the present invention, the communication system may at least comprise a BS and a UE in cellular communication with the BS, and wherein the D2D communication is performed between a D2D transmitter and a D2D receiver and interferes with the cellular communication. According to embodiments of the present invention, the communication system may be implemented as the system illustrated in FIG. 1A or FIG. 1B. The apparatus 500 may be implemented in the D2D transmitter or some other places which is suitable for implementing the apparatus 500.

According to embodiments of the present invention, the apparatus 500 may comprise: a obtaining unit 510 configured to obtain modulation and coding scheme (MCS) information on the cellular communication between the BS and the UE; and a determining unit 520 configured to determine a transmitting power for the D2D communication based on the MCS information, so as to reduce the interference from the D2D communication to the cellular communication.

According to embodiments of the present invention, the cellular communication may be in uplink, and the obtaining unit 510 may comprise: means configured to obtain the MCS information transmitted from the BS to the UE, wherein the MCS information is designated by the BS to the UE.

According to embodiments of the present invention, the cellular communication is may be in downlink, and the obtaining unit 510 may comprise: means configured to obtain the MCS information transmitted from the BS to the UE, wherein the MCS information is determined by the BS based on CQI measured by the UE in response to receiving reference signals from the BS.

According to embodiments of the present invention, the determining unit 520 may comprise: obtaining means configured to obtain a power limit for all of at least one shared subband which is shared by the D2D communication and the cellular communication based on the MCS information; and determining means configured to determine the transmitting power for the D2D communication based on the power limit.

According to embodiments of the present invention, the cellular communication may be in uplink, and the obtaining means may comprise: means configured to obtain the channel information from the UE to the BS based on the MCS information; means configured to obtain channel information from the D2D transmitter to the BS based on pathloss from the D2D transmitter to the BS; and means configured to calculate the power limit for all of the at least one shared subband based on the channel information from the UE to the BS, the channel information from the D2D transmitter to the BS, and outage probability of the uplink.

According to embodiments of the present invention, the means configured to obtain channel information from the D2D transmitter to the BS based on pathloss from the D2D transmitter to the BS may comprise: means configured to calculate the pathloss from the BS to the D2D transmitter based on reference signals sent from the BS; and means configured to obtain the pathloss from the D2D transmitter to the BS based on channel reciprocity and the pathloss from the BS to the D2D transmitter.

According to embodiments of the present invention, the cellular communication may be in downlink, and the obtaining means may comprise: means configured to obtain the channel information from the BS to the UE based on the MCS information; means configured to obtain channel information from the D2D transmitter to the UE based on pathloss from the D2D transmitter to the UE; and means configured to calculate the power limit for all of the at least one shared subband based on the channel information from the UE to the BS, the channel information from the D2D transmitter to the UE, and outage probability of the downlink.

According to embodiments of the present invention, the means configured to obtain channel information from the D2D transmitter to the UE based on pathloss from the D2D transmitter to the UE may comprise: means configured to determine the distance between the D2D transmitter and the UE; and means configured to calculate the pathloss from the D2D transmitter to the UE based on the distance between the D2D transmitter and the UE.

According to embodiments of the present invention, the determining means may comprise: means configured to obtain the total power limitation at the D2D transmitter; and means configured to determine the transmitting power for the D2D communication based on the power limit for all of the at least one shared subband and the total power limitation.

According to embodiments of the present invention, the means configured to determine the transmitting power for the D2D communication based on the power limit for all of the at least one shared subband and the total power limitation may comprise: means configured to obtain interference suffered by the D2D receiver; means configured to calculate a transmission rate for each of the at least one shared subband based on the obtained interference; and means configured to obtain a subband transmitting power for each of the at least one shared subband by maximizing the sum of the calculated transmission rate, wherein each subband transmitting power does not exceed the power limit for the corresponding subband, and the sum of subband transmitting powers does not exceed the total power limitation.

According to embodiments of the present invention, the means configured to obtain interference suffered by the D2D receiver may comprise: means configured to obtain long term interference to the D2D receiver, wherein the long term interference is estimated based on historical interference at the D2D receiver or set as a predetermined value.

According to embodiments of the present invention, the means configured to obtain interference suffered by the D2D receiver may comprise: means configured to obtain instantaneous interference to the D2D receiver, wherein the instantaneous interference is measured by the D2D receiver for each of at least one shared subband which is shared by the UE and the D2D transmitter.

It is noted that the apparatus 500 may be configured to implement functionalities as described with reference to FIGS. 2-4. Therefore, the features discussed with respect to any of methods 200, 300 and 400 may apply to the corresponding components of the apparatus 500. It is further noted that the components of the apparatus 500 may be embodied in hardware, software, firmware, and/or any combination thereof. For example, the components of the apparatus 500 may be respectively implemented by a circuit, a processor or any other appropriate device. Those skilled in the art will appreciate that the aforesaid examples are only for illustration not limitation.

In some embodiment of the present disclosure, the apparatus 500 comprises at least one processor. The at least one processor suitable for use with embodiments of the present disclosure may include, by way of example, both general and special purpose processors already known or developed in the future. The apparatus 500 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 500 to at least perform according to any of methods 200, 300 and 400 as discussed above.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in FIGS. 2-4 may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

What is claimed is:

1. A method for performing D2D (Device-to-Device) communication in a communication system, wherein the communication system at least comprises a base station (BS) and a user equipment (UE) in cellular communication with the BS, and wherein the D2D communication is performed between a D2D transmitter and a D2D receiver and interferes with the cellular communication, the method comprising:
obtaining modulation and coding scheme (MCS) information on the cellular communication between the BS and the UE; and
determining a transmitting power for the D2D communication based on the MCS information, so as to reduce the interference from the D2D communication to the cellular communication.

2. The method of claim 1, wherein the cellular communication is in uplink, and wherein obtaining the MCS information on the cellular communication between the BS and the UE comprises:
obtaining the MCS information transmitted from the BS to the UE, wherein the MCS information is designated by the BS to the UE.

3. The method of claim 1, wherein the cellular communication is in downlink, and wherein obtaining the MCS information on the cellular communication between the BS and the UE comprises:
obtaining the MCS information transmitted from the BS to the UE, wherein the MCS information is determined by the BS based on CQI measured by the UE in response to receiving reference signals from the BS.

4. The method of claim 1, wherein determining a transmitting power for the D2D communication based on the MCS information comprises:
obtaining a power limit for all of at least one shared subband which is shared by the D2D communication and the cellular communication based on the MCS information; and
determining the transmitting power for the D2D communication based on the power limit.

5. The method of claim 4, wherein the cellular communication is in uplink, and wherein obtaining a power limit for all of at least one shared subband which is shared by the D2D communication and the cellular communication based on the MCS information comprises:
obtaining the channel information from the UE to the BS based on the MCS information;
obtaining channel information from the D2D transmitter to the BS based on pathloss from the D2D transmitter to the BS; and
calculating the power limit for all of the at least one shared subband based on the channel information from the UE to the BS, the channel information from the D2D transmitter to the BS, and outage probability of the uplink.

6. The method of claim 5, wherein obtaining channel information from the D2D transmitter to the BS based on pathloss from the D2D transmitter to the BS comprises:
calculating the pathloss from the BS to the D2D transmitter based on reference signals sent from the BS; and
obtaining the pathloss from the D2D transmitter to the BS based on channel reciprocity and the pathloss from the BS to the D2D transmitter.

7. The method of claim 4, wherein the cellular communication is in downlink, and wherein obtaining a power limit for all of at least one shared subband shared by the D2D communication and the cellular communication based on the MCS information comprises:
obtaining the channel information from the BS to the UE based on the MCS information;
obtaining channel information from the D2D transmitter to the UE based on pathloss from the D2D transmitter to the UE; and
calculating the power limit for all of the at least one shared subband based on the channel information from the UE to the BS, the channel information from the D2D transmitter to the UE, and outage probability of the downlink.

8. The method of claim 7, wherein obtaining channel information from the D2D transmitter to the UE based on pathloss from the D2D transmitter to the UE comprises:
determining the distance between the D2D transmitter and the UE; and
calculating the pathloss from the D2D transmitter to the UE based on the distance between the D2D transmitter and the UE.

9. The method of claim 4, wherein determining the transmitting power for the D2D communication based on the power limit comprises:
obtaining the total power limitation at the D2D transmitter; and
determining the transmitting power for the D2D communication based on the power limit for all of the at least one shared subband and the total power limitation.

10. The method of claim 9, wherein determining the transmitting power for the D2D communication based on the power limit for all of the at least one shared subband and the total power limitation comprises:
obtaining interference suffered by the D2D receiver;
calculating a transmission rate for each of the at least one shared subband based on the obtained interference; and
obtaining a subband transmitting power for each of the at least one shared subband by maximizing the sum of the calculated transmission rate, wherein each subband transmitting power does not exceed the power limit for the corresponding subband, and the sum of subband transmitting powers does not exceed the total power limitation.

11. The method of claim 10, wherein obtaining interference suffered by the D2D receiver comprises:
obtaining long term interference to the D2D receiver, wherein the long term interference is estimated based on historical interference at the D2D receiver or set as a predetermined value.

12. The method of claim 10, wherein obtaining interference suffered by the D2D receiver comprises:
obtaining instantaneous interference to the D2D receiver, wherein the instantaneous interference is measured by the D2D receiver for each of the at least one shared subband which is shared by the UE and the D2D transmitter.

13. An apparatus for performing D2D (Device-to-Device) communication in a communication system, wherein the communication system at least comprises a base station (BS) and a user equipment (UE) in cellular communication with the BS, and wherein the D2D communication is performed between a D2D transmitter and a D2D receiver and interferes with the cellular communication, the apparatus comprising:
obtaining unit configured to obtain modulation and coding scheme (MCS) information on the cellular communication between the BS and the UE; and
determining unit configured to determine a transmitting power for the D2D communication based on the MCS information, so as to reduce the interference from the D2D communication to the cellular communication.

14. The apparatus of claim 13, wherein the cellular communication is in uplink, and wherein the obtaining unit comprises:
means configured to obtain the MCS information transmitted from the BS to the UE, wherein the MCS information is designated by the BS to the UE.

15. The apparatus of claim 13, wherein the cellular communication is in downlink, and wherein the obtaining unit comprises:
means configured to obtain the MCS information transmitted from the BS to the UE, wherein the MCS information is determined by the BS based on CQI measured by the UE in response to receiving reference signals from the BS.

16. The apparatus of claim 13, wherein the determining unit comprises:
obtaining means configured to obtain a power limit for all of at least one shared subband which is shared by the D2D communication and the cellular communication based on the MCS information; and
determining means configured to determine the transmitting power for the D2D communication based on the power limit.

17. The apparatus of claim 16, wherein the cellular communication is in uplink, and wherein the obtaining means comprises:
means configured to obtain the channel information from the UE to the BS based on the MCS information;
means configured to obtain channel information from the D2D transmitter to the BS based on pathloss from the D2D transmitter to the BS; and
means configured to calculate the power limit for all of the at least one shared subband based on the channel information from the UE to the BS, the channel information from the D2D transmitter to the BS, and outage probability of the uplink.

18. The method of claim 17, wherein the means configured to obtain channel information from the D2D transmitter to the BS based on pathloss from the D2D transmitter to the BS comprises:
means configured to calculate the pathloss from the BS to the D2D transmitter based on reference signals sent from the BS; and
means configured to obtain the pathloss from the D2D transmitter to the BS based on channel reciprocity and the pathloss from the BS to the D2D transmitter.

19. The apparatus of claim 16, wherein the cellular communication is in downlink, and wherein the obtaining means comprises:
means configured to obtain the channel information from the BS to the UE based on the MCS information;
means configured to obtain channel information from the D2D transmitter to the UE based on pathloss from the D2D transmitter to the UE; and
means configured to calculate the power limit for all of the at least one shared subband based on the channel information from the UE to the BS, the channel information from the D2D transmitter to the UE, and outage probability of the downlink.

20. The method of claim 19, wherein the means configured to obtain channel information from the D2D transmitter to the UE based on pathloss from the D2D transmitter to the UE comprises:
means configured to determine the distance between the D2D transmitter and the UE; and
means configured to calculate the pathloss from the D2D transmitter to the UE based on the distance between the D2D transmitter and the UE.

21. The apparatus of claim 16, wherein the determining means comprises:
means configured to obtain the total power limitation at the D2D transmitter; and
means configured to determine the transmitting power for the D2D communication based on the power limit for all of the at least one shared subband and the total power limitation.

22. The apparatus of claim 21, wherein the means configured to determine the transmitting power for the D2D communication based on the power limit for all of the at least one shared subband and the total power limitation comprises:
means configured to obtain interference suffered by the D2D receiver;
means configured to calculate a transmission rate for each of the at least one shared subband based on the obtained interference; and
means configured to obtain a subband transmitting power for each of the at least one shared subband by maximizing the sum of the calculated transmission rate, wherein each subband transmitting power does not exceed the power limit for the corresponding subband, and the sum of subband transmitting powers does not exceed the total power limitation.

23. The apparatus of claim 22, wherein the means configured to obtain interference suffered by the D2D receiver comprises:
means configured to obtain long term interference to the D2D receiver, wherein the long term interference is estimated based on historical interference at the D2D receiver or set as a predetermined value.

24. The apparatus of claim 22, wherein the means configured to obtain interference suffered by the D2D receiver comprises:
means configured to obtain instantaneous interference to the D2D receiver, wherein the instantaneous interference is measured by the D2D receiver for each of at least one shared subband which is shared by the UE and the D2D transmitter.
